(19) United States
(12) Patent Application Publication
(10) Pub. No.: US 2026/0344670 A1
(43) Pub. Date: Nov. 5, 2026

(54) BIXLOZONE MIXTURES WITH PETHOXAMID

(71) Applicant: FMC CORPORATION, Philadelphia, PA (US)

(72) Inventors: David HENNENS, Bekkevoort (BE); Jesper HILDEBRANDT, Copenhagen (DK)

(21) Appl. No.: 19/115,812

(22) PCT Filed: Sep. 29, 2023
(86) PCT No.: PCT/US2023/034070

§ 371 Date: Mar. 27, 2025

Related U.S. Application Data
(60) Provisional application No. 63/412,293, filed on Sep. 30, 2022.

(51) Int. Cl. A01N 43/80; A01N 25/28; A01N 37/20; A01P 13/02

(52) U.S. Cl. CPC A01N 43/80; A01N 25/28; A01N 37/20; A01P 13/02

(57) ABSTRACT

Presented are agrochemical compositions comprising as active ingredients bixlozone and pethoxamid. The combinations of these active compounds show a synergistic effect in the control of harmful plants.

### FIELD OF THE DISCLOSURE

Described herein are agrochemical compositions comprising mixtures of bixlozone and pethoxamid. It has been surprisingly found that mixtures of bixlozone and pethoxamid produce synergistic effects compared to the individual components in the control of harmful plants. Also described herein is a method for the control of harmful plants, such as weeds in crops of useful plants. Also described herein is a use of the herbicidal compositions for the control of harmful plants.

### BACKGROUND OF THE DISCLOSURE

In agrochemical products, it is always desirable to increase the specific activity of an active ingredient and the reliability of action.

The herbicidal active compound pethoxamid is known from EP0206251 and is generally used to control weeds in various crops such as control of grass weeds and broad-leaved weeds. The herbicidal active compound bixlozone is known from U.S. Pat. No. 4,405,357 and is also generally used to control weeds in various crops such as control of grass weeds and broad-leaved weeds. Compositions including pethoxamid and/or bixlozone are broadly described in US20170042155, U.S. Pat. Nos. 9,814,237, and 10,667,516. However, no specific combinations of pethoxamid and bixlozone have been demonstrated.

Surprisingly, it has now been found that combinations of bixlozone and pethoxamid active compounds exhibits a synergistic effect when used for the control of harmful plants. Accordingly, it is an object of the present disclosure to provide mixtures comprising bixlozone and pethoxamid.

### BRIEF DESCRIPTION OF THE DISCLOSURE

In one embodiment, the present disclosure is directed to an agrochemical composition comprising bixlozone and pethoxamid as herbicidally active components, wherein the bixlozone is encapsulated, non-encapsulated, or a mixture of encapsulated and non-encapsulated, wherein the bixlozone and the pethoxamid are present in synergistically effective amounts, and wherein the bixlozone and the pethoxamid are present in a ratio in the range of from about 1.25:1 to about 1:8.

In another embodiment, the present disclosure is directed to a method of preparing an agrochemical composition, the method comprising forming a mixture comprising (i) bixlozone, wherein the bixlozone is encapsulated, non-encapsulated, or a mixture of encapsulated and non-encapsulated, and (ii) pethoxamid, wherein the bixlozone and the pethoxamid are present in synergistically effective amounts, and wherein the bixlozone and the pethoxamid are present in a ratio of bixlozone:pethoxamid in the range of from about 1.25:1 to about 1:8.

In yet another embodiment, the present disclosure is directed to a method for controlling undesirable vegetation, the method comprising applying to the undesirable vegetation or to a locus thereof or applying to a soil to prevent an emergence or growth of the undesirable vegetation an agrochemical composition comprising bixlozone and pethoxamid, wherein the bixlozone is encapsulated, non-encapsulated, or a mixture of encapsulated and non-encapsulated, wherein the bixlozone and the pethoxamid are present in synergistically effective amounts, and wherein the bixlozone and the pethoxamid are present in a ratio of bixlozone:pethoxamid in the range of from about 1.25:1 to about 1:8.

### DETAILED DESCRIPTION OF THE DISCLOSURE

Described herein are mixtures comprising bixlozone and pethoxamid as herbicidally active ingredients. The mixtures exhibit a synergistic effect when used for the control of harmful plants.

The present invention comprises, or consists essentially of, synergistic combinations of bixlozone and pethoxamid combined in the ratios disclosed herein and methods for effective use of said synergistic combinations. The mixtures of the present invention can include other components, including other active components, to enhance the performance properties of said mixtures. For the avoidance of doubt the present invention does not require other active components to provide the claimed synergistic effect and, thus, other active components may be excluded from the present invention without detriment to the surprising effects of the claimed invention described herein.

Generally, agrochemical compositions in accordance with the present disclosure comprise bixlozone and pethoxamid in synergistically effective amounts. The effectiveness of said agrochemical compositions used in methods for the control of harmful plants will depend on various factors such as the mode of application, the harmful plants to be combated, the useful plant to be protected, the application time, etc. Methods of using of said synergistically effective compositions can be readily determined by the skilled person using well known principles.

In many embodiments, bixlozone and pethoxamid are present and/or applied in a ratio of bixlozone to pethoxamid that is an effective amount, and that is preferably selected to provide a synergistic herbicidal action. An effective amount of bixlozone and pethoxamid is any amount that has the ability to combat the harmful plants. The ratio may be a weight ratio, a molar ratio, an application rate ratio, or a volume ratio.

In some embodiments, bixlozone and pethoxamid are present and/or applied in a ratio of bixlozone:pethoxamid in the range of from about 30:1, about 29:1, about 28:1, about 27:1, about 26:1, about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, about 1.75:1, about 1.5:1, about 1.25:1, or about 1:1 to about 1:2, about 1:3, about 1:4, about 1:5, about 1:6, about 1:7, about 1:8, about 1:9, about 1:10, about 1:11, about 1:12, about 1:13, about 1:14, about 1:15, about 1:16, about 1:17, about 1:18, about 1:19, about 1:20, about 1:21, about 1:22, about 1:23, about 1:24, about 1:25, about 1:26, about 1:27, about 1:28, about 1:29, or about 1:30.

In some embodiments, bixlozone and pethoxamid are present in a ratio in the range of from about 30:1 to about 1:30. In some embodiments, bixlozone and pethoxamid are present in a ratio in the range of from about 15:1 to about 1:15. In some embodiments, bixlozone and pethoxamid are present in a ratio in the range of from about 8:1 to about 1:8. In some embodiments, bixlozone and pethoxamid are present in a ratio in the range of from about 6:1 to about 1:6. In some embodiments, bixlozone and pethoxamid are present in a ratio in the range of from about 3:1 to about 1:3. In some embodiments, bixlozone and pethoxamid are present in a ratio in the range of from about 2:1 to about 1:2.

In some particular embodiments, bixlozone and pethoxamid are present in a ratio of bixlozone:pethoxamid in the range of from about 1.25:1 to about 1:8. In some particular embodiments, bixlozone and pethoxamid are present in a ratio in the range of from about 1.25:1 to about 1:3.2.

In some embodiments, bixlozone is employed in an amount of from about 1 g/ha, about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha, to about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha. However, higher and lower doses may also provide adequate control.

In some embodiments, bixlozone is employed in an amount of from about 100 g/ha to about 400 g/ha.

In some embodiments, pethoxamid is employed in an amount of from about 1 g/ha, about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha, to about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha. However, higher and lower doses may also provide adequate control.

In some embodiments, pethoxamid is employed in an amount of from about 100 g/ha to about 1500 g/ha. In some embodiments, pethoxamid is employed in an amount of from about 100 g/ha to about 800 g/ha. In some embodiments, pethoxamid is employed in an amount of from about 100 g/ha to about 300 g/ha. In some embodiments, pethoxamid is employed in an amount of from about 300 g/ha to about 1200 g/ha.

Rates of application of the agrochemical composition will vary according to prevailing conditions such as targeted weeds, degree of infestation, weather conditions, soil conditions, crop species, mode of application, and application time. Compositions containing the active compounds may be applied in the form in which they are formulated. For example, they may be applied as sprays, such as water-dispersible concentrates, wettable powders, or water-dispersible granules. In the practice of the present invention rates of application of bixlozone and pethoxamid can be varied independent of each other, provided that all combinations are synergistic and that each of the components are applied within the disclosed limits of the present invention.

In many embodiments, the synergy between the bixlozone and pethoxamid in the agrochemical compositions according to the present disclosure is independent of the form of the agrochemical composition. Accordingly, agrochemical compositions according to the present disclosure may be in any suitable form of agrochemical compositions known in the art. The agrochemical compositions may include bixlozone and pethoxamid in the same form or different forms. In some embodiments, the agrochemical composition is in a form selected from twin packs, ready-to-use solutions, emulsifiable concentrates, emulsions, suspensions, wettable powders, soluble powders, granules, soluble granules, dispersible granules, microemulsions, microcapsule suspensions (e.g., capsules comprising both active ingredients or present within separate capsules), and combinations thereof.

Particularly preferred formulations of agrochemical compositions in accordance with the present disclosure include suspension concentrates (SC), capsule suspension concentrates (CS), mixtures of SC and CS formulations (ZC), emulsifiable concentrates (EC), granules (GR), water dispersible granules (WG), and combinations thereof.

In some embodiments, the bixlozone is in a form selected from a suspension concentrate, a capsule suspension, an emulsifiable concentrate, a granule, a wettable granule, and combinations thereof.

In some embodiments, the pethoxamid is in a form selected from a suspension concentrate, a capsule suspension, a granule, a wettable granule, and combinations thereof. In some embodiments, the pethoxamid is in a form selected from a suspension concentrate, an emulsifiable concentrate, a granule, a wettable granule, and combinations thereof. In some embodiments, the pethoxamid is in a form of a suspension concentrate.

In some embodiments, the bixlozone and pethoxamid are capsulated together in a co-encapsulation (co-CS). In some embodiments, the bixlozone and pethoxamid are separately encapsulated.

Generally, the active ingredients of the agrochemical compositions may be encapsulated with encapsulation materials known in the art. Biodegradable and sustainable encapsulation materials are particularly preferred. In some embodiments, an amount of the bixlozone is encapsulated with a material selected from polyurea, a biodegradable natural polymer, chitosan, wax, alginate, cellulose, gelatin, and combinations thereof. In some embodiments, an amount of the pethoxamid is encapsulated with a material selected from polyurea, a biodegradable natural polymer, chitosan, wax, alginate, cellulose, gelatin, and combinations thereof.

In some particular embodiments, the agrochemical compositions comprise encapsulated bixlozone, non-encapsulated bixlozone, and pethoxamid.

In some embodiments, the active ingredients are present in a ratio of encapsulated:non-encapsulated ingredients in the range of from about 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or 1:1 to about 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, or 1:30.

In some particular embodiments, the active ingredients are present in a ratio of encapsulated:non-encapsulated ingredients in the range of from about 9:1 to about 1:9. In some particular embodiments, the active ingredients are present in a ratio of encapsulated:non-encapsulated ingredients in the range of from about 4:1 to about 1:4. In some particular embodiments, the active ingredients are present in a ratio of encapsulated:non-encapsulated ingredients in the range of from about 3:1 to about 1:3. In some embodiments the encapsulated:non-encapsulated active ingredients are encapsulated bixlozone and non-encapsulated bixlozone.

The agrochemical compositions may be applied in various combinations of the two active compounds. For example, they may be applied as a single “ready-mix” form, or in a combined spray mixture composed from separate formulations of the active compounds, e.g., a “tank-mix” form. Thus, to be used in combination, it is not necessary that the two active compounds be applied in a physically combined form, or even at the same time, i.e. the components may be applied in a separately and/or sequentially application, provided that the application of the second active compound occurs within a reasonable period of time from the application of the first active compound. The combination effect results so long as the two active compounds are present at the same time, regardless of when they were applied. Thus, for instance, a physical combination of the two active compounds could be applied, or one could be applied earlier than the other so long as the earlier-applied active compound is still present on the harmful plant to be controlled or in the soil surrounding the harmful plant to be controlled when the second active compound is applied, and so long as the weight ratio of available active compounds falls within that provided herein. The order of applying the individual components bixlozone and pethoxamid is not essential. Likewise, any form of combination of the active components may be applied for either pre- or post-emergence control of harmful plants, e.g., weeds in crops of useful plants.

In some particular embodiments, the agrochemical composition is in a form selected from a premix and a tank mix.

Agrochemical compositions in accordance with the present disclosure may be formulated using auxiliaries, adjuvants, and formulation techniques that are known in the art for individually formulating the active compounds. For example, the active compounds may be mixed together, optionally with other formulating ingredients.

The agrochemical compositions may contain a diluent, which may be added during the formulation process, after the formulation process (e.g., by the user—a farmer or custom applicator), or both. The term diluent includes all liquid and solid agriculturally acceptable material-including carriers which may be added to the herbicides to bring them in a suitable application or commercial form and include solvents, emulsifiers, and dispersants. Examples of suitable solid diluents or carriers are aluminum silicate, talc, calcined magnesia, kieselguhr, tricalcium phosphate, powdered cork, absorbent carbon black, chalk, silica, and clays such as kaolin and bentonite. Examples of suitable liquid diluents include water, organic solvents (e.g., acetophenone, cyclohexanone, isophorone, toluene, xylene, petroleum distillates), amines (e.g., ethanolamine, dimethylformamide), and mineral, animal, and vegetable oils (used alone or in combination).

The agrochemical compositions may also contain surfactants, protective colloids, thickeners, penetrating agents, stabilizers, sequestering agents, anti-caking agents, coloring agents, corrosion inhibitors, and dispersants such as lignosulfite waste liquors and methylcellulose. The term surfactant, as used herein, means an agriculturally acceptable material which imparts emulsifiability, stability, spreading, wetting, dispersibility or other surface-modifying properties. Examples of suitable surfactants include lignin sulfonates, fatty acid sulfonates (e.g., lauryl sulfonate), the condensation product of formaldehyde with naphthalene sulfonate, alkylarylsulfonates, ethoxylated alkylphenols, and ethoxylated fatty alcohols. Other known surfactants that have been used with herbicides are also acceptable.

In some embodiments, the agrochemical composition further comprises an auxiliary selected from dispersants, surfactants, biocides, antifoamers, antifreeze agents, rheology modifiers, surfactants, solvents, and combinations thereof.

When mixed with additional components, the agrochemical compositions of the present invention typically contain a total of from about 0.01 to about 95% by weight of the synergistic active compounds, about 0 to about 20% agriculturally acceptable surfactants, and about 5 to 99.99% solid or liquid diluent(s). The agrochemical compositions may additionally contain other additives known in the art, such as pigments, thickeners and the like.

When mixed with additional components, the agrochemical compositions of the present invention typically contain the combined active ingredients at a total normality in the range of from about 0.001 N to about 10 N. In some embodiments, the agrochemical compositions typically contain the combined active ingredients at a total normality in the range of from about 0.01 N to about 2 N.

Additional herbicides may be also be used, preferably so provided that the additional herbicide does not interfere with the synergistic relationship between bixlozone and the pethoxamid. An additional herbicide may be utilized if broadening of the spectrum of control or preventing the build-up of resistance is desired.

In one embodiment, examples of additional herbicides are acetochlor, acifluorfen and its sodium salt, aclonifen, acrolein (2-propenal), alachlor, alloxydim, ametryn, amicarbazone, amidosulfuron, aminocyclopyrachlor and its esters (e.g., methyl, ethyl) and salts (e.g., sodium, potassium), aminopyralid, amitrole, ammonium sulfamate, anilofos, asulam, atrazine, azimsulfuron, bixlozone, beflubutamid, beflubutamid-M, benazolin, benazolin-ethyl, bencarbazone, benfluralin, benfuresate, benquinotrione, bensulfuron-methyl, bensulide, bentazone, benzobicyclon, benzofenap, bicyclopyrone, bifenox, bilanafos, bipyrazone, bispyribac and its sodium salt, broclozone, bromacil, bromobutide, bromofenoxim, bromoxynil, bromoxynil octanoate, butachlor, butafenacil, butamifos, butralin, butroxydim, butylate, cafenstrole, carbetamide, carfentrazone-ethyl, catechin, chlomethoxyfen, chloramben, chlorbromuron, chlorflurenol-methyl, chloridazon, chlorimuron-ethyl, chlorotoluron, chlorpropham, chlorsulfuron, chlorthal-dimethyl, chlorthiamid, cinidon-ethyl, cinmethylin, cinosulfuron, clacyfos, clefoxydim, clethodim, clodinafop-propargyl, clomazone, clomeprop, clopyralid, clopyralid-olamine, cloransulam-methyl, cumyluron, cyanazine, cycloate, cyclopyranil, cyclopyrimorate, cyclosulfamuron, cycloxydim, cyhalofop-butyl, cypyrafluone, 2,4-D and its butotyl, butyl, isoctyl and isopropyl esters and its dimethylammonium, diolamine and trolamine salts, daimuron, dalapon, dalapon-sodium, dazomet, 2,4-DB and its dimethylammonium, potassium and sodium salts, desmedipham, desmetryn, dicamba and its diglycolammonium, dimethylammonium, potassium and sodium salts, dichlobenil, dichlorprop, diclofop-methyl, diclosulam, difenzoquat metilsulfate, diflufenican, diflufenzopyr, dimefuron, dimesulfazet, dimepiperate, dimesulfazet, dimethachlor, dimethametryn, dimethenamid, dimethenamid-P, dimethipin, dimethylarsinic acid and its sodium salt, dinitramine, dinoterb, dioxopyritrione, diphenamid, diquat dibromide, dithiopyr, diuron, DNOC, endothal, EPTC, epyrifenacil, esprocarb, ethalfluralin, ethametsulfuron-methyl, ethiozin, ethofumesate, ethoxyfen, ethoxysulfuron, etobenzanid, fenoxaprop-ethyl, fenoxaprop-P-ethyl, fenoxasulfone, fenpyrazone, fenquinotrione, fentrazamide, fenuron, fenuron-TCA, flamprop-methyl, flamprop-M-isopropyl, flamprop-M-methyl, flazasulfuron, florasulam, fluazifop-butyl, fluazifop-P-butyl, fluazolate, flucarbazone, flucetosulfuron, fluchloralin, fluchloraminopyr, flufenacet, flufenoximacil, flufenpyr, flufenpyr-ethyl, flumetsulam, flumiclorac-pentyl, flumioxazin, fluometuron, fluoroglycofen-ethyl, flupoxam, flupyrsulfuron-methyl and its sodium salt, flurenol, flurenol-butyl, fluridone, flurochloridone, fluroxypyr, flurtamone, flusulfinam, fluthiacet-methyl, fomesafen, foramsulfuron, fosamine-ammonium, glufosinate, glufosinate-ammonium, L-glufosinate-ammonium, glufosinate-P, glyphosate and its salts such as ammonium, isopropylammonium, potassium, sodium (including sesquisodium) and trimesium (alternatively named sulfosate), halauxifen, halauxifen-methyl, halosulfuron-methyl, haloxyfop-etotyl, haloxyfop-methyl, hexazinone, hydantocidin, icafolin, imazamethabenz-methyl, imazamox, imazapic, imazapyr, imazaquin, imazaquin-ammonium, imazethapyr, imazethapyr-ammonium, imazosulfuron, indanofan, indaziflam, indolauxipyr, iofensulfuron, iodosulfuron-methyl, ioxynil, ioxynil octanoate, ioxynil-sodium, ipfencarbazone, iptriazopyrid, isoproturon, isouron, isoxaben, isoxaflutole, isoxachlortole, lactofen, lancotrione, lenacil, linuron, maleic hydrazide, MCPA and its salts (e.g., MCPA-dimethylammonium, MCPA-potassium and MCPA-sodium, esters (e.g., MCPA-2-ethylhexyl, MCPA-butotyl) and thioesters (e.g., MCPA-thioethyl), MCPB and its salts (MCPB-sodium) and esters (e.g., MCPB-ethyl), mecoprop, mecoprop-P, mefenacet, mefluidide, mesosulfuron-methyl, mesotrione, metam-sodium, metamifop, metamitron, metazachlor, metazosulfuron, methabenzthiazuron, methylarsonic acid and its calcium, monoammonium, monosodium and disodium salts, methyldymron, metobenzuron, metobromuron, metolachlor, S-metolachlor, metosulam, metoxuron, metproxybicyclone, metribuzin, metsulfuron-methyl, molinate, monolinuron, naproanilide, napropamide, napropamide-M, naptalam, neburon, nicosulfuron, norflurazon, orbencarb, orthosulfamuron, oryzalin, oxadiargyl, oxadiazon, oxasulfuron, oxaziclomefone, oxyfluorfen, paraquat dichloride, pebulate, pelargonic acid, pendimethalin, penoxsulam, pentanochlor, pentoxazone, perfluidone, pethoxamid, pethoxyamid, phenmedipham, picloram, picloram-potassium, picolinafen, pinoxaden, piperophos, pretilachlor, primisulfuron-methyl, prodiamine, profoxydim, prometon, prometryn, propachlor, propanil, propaquizafop, propazine, propham, propisochlor, propoxycarbazone, propyrisulfuron, propyzamide, prosulfocarb, prosulfuron, pyraclonil, pyraflufen-ethyl, pyrasulfotole, pyrazogyl, pyrazolynate, pyrazoxyfen, pyrazosulfuron-ethyl, pyribenzoxim, pyributicarb, pyridate, pyriflubenzoxim, pyriftalid, pyriminobac-methyl, pyrimisulfan, pyrithiobac, pyrithiobac-sodium, pyroxasulfone, pyroxsulam, quinclorac, quinmerac, quinoclamine, quizalofop-ethyl, quizalofop-P-ethyl, quizalofop-P-tefuryl, rimisoxafen, rimsulfuron, saflufenacil, sethoxydim, siduron, simazine, simetryn, sulcotrione, sulfentrazone, sulfometuron-methyl, sulfosulfuron, 2,3,6-TBA, TCA, TCA-sodium, tebutam, tebuthiuron, tefuryltrione, tembotrione, tepraloxydim, terbacil, terbumeton, terbuthylazine, terbutryn, tetflupyrolimet, thenylchlor, thiazopyr, thiencarbazone, thifensulfuron-methyl, thiobencarb, tiafenacil, tiocarbazil, tolpyralate, topramezone, tralkoxydim, tri-allate, triafamone, triasulfuron, triaziflam, tribenuron-methyl, triclopyr, triclopyr-butotyl, triclopyr-triethylammonium, tridiphane, trietazine, trifloxysulfuron, trifludimoxazin, trifluralin, triflusulfuron-methyl, tripyrasulfone, tritosulfuron, vernolate, 3-(2-chloro-3,6-difluorophenyl)-4-hydroxy-1-methyl-1,5-naphthyridin-2(1H)-one, 6-chloro-4-(2,7-dimethyl-1-naphthalenyl)-5-hydroxy-2-methyl-3(2H)-pyridazinone, 5-chloro-3-[(2-hydroxy-6-oxo-1-cyclohexen-1-yl) carbonyl]-1-(4-methoxyphenyl)-2(1H)-quinoxalinone, 2-chloro-N-(1-methyl-1H-tetrazol-5-yl)-6-(trifluoromethyl)-3-pyridinecarboxamide, 7-(3,5-dichloro-4-pyridinyl)-5-(2,2-difluoroethyl)-8-hydroxypyrido[2,3-b]pyrazin-6(5H)-one), 4-(2,6-diethyl-4-methylphenyl)-5-hydroxy-2,6-dimethyl-3(2H)-pyridazinone), 5-[[(2,6-difluorophenyl) methoxy]methyl]-4,5-dihydro-5-methyl-3-(3-methyl-2-thienyl) isoxazole (previously methioxolin), 4-(4-fluorophenyl)-6-[(2-hydroxy-6-oxo-1-cyclohexen-1-yl) carbonyl]-2-methyl-1,2,4-triazine-3,5(2H,4H)-dione, methyl 4-amino-3-chloro-6-(4-chloro-2-fluoro-3-methoxyphenyl)-5-fluoro-2-pyridinecarboxylate, 2-methyl-3-(methylsulfonyl)-N-(1-methyl-1H-tetrazol-5-yl)-4-(trifluoromethyl)benzamide, 2-methyl-N-(4-methyl-1,2,5-oxadiazol-3-yl)-3-(methylsulfinyl)-4-(trifluoromethyl)benzamide, or their environmentally compatible salts, “acids”, esters and amides. Other herbicides also include bioherbicides such as Alternaria destruens Simmons, Colletotrichum gloeosporiodes (Penz.) Penz. & Sacc., Drechsiera monoceras (MTB-951), Myrothecium verrucaria (Albertini & Schweinitz) Ditmar: Fries, Phytophthora palmivora (Butl.) Butl., Puccinia thlaspeos Schub, or their environmentally compatible salts, “acids”, esters and amides.

Preferred for better control of undesirable vegetation (e.g., lower use rate such as from enhanced effects, broader spectrum of weeds controlled, or enhanced crop safety) or for preventing the development of resistant weeds are mixtures of a compound of this invention with a herbicide selected from atrazine, azimsulfuron, S-beflubutamid, benzisothiazolinone, carfentrazone-ethyl, chlorimuron-ethyl, chlorsulfuron-methyl, clomazone, clopyralid potassium, cloransulam-methyl, 2-[(2,5-dichlorophenyl)methyl]-4,4-dimethyl-3-isoxazolidinone, ethametsulfuron-methyl, flumetsulam, flupyrsulfuron-methyl, fluthiacet-methyl, fomesafen, imazethapyr, lenacil, mesotrione, metribuzin, metsulfuron-methyl, pethoxamid, picloram, pyroxasulfone, quinclorac, rimsulfuron, S-metolachlor, sulfentrazone, thifensulfuron-methyl, triflusulfuron-methyl, tribenuron-methyl, or their environmentally compatible salts, “acids”, esters and amides.

In another embodiment, examples of additional herbicides are acetyl-CoA carboxylase inhibitors (ACC), for example cyclohexenone oxime ethers, such as alloxydim, clethodim, cloproxydim, cycloxydim, sethoxydim, tralkoxydim, butroxydim, clefoxydim or tepraloxydim; phenoxyphenoxypropionic esters, such as clodinafop-propargyl, cyhalofopbutyl, diclofop-methyl, fenoxaprop-ethyl, fenoxaprop-P-ethyl, fenthiapropethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl; or arylaminopropionic acids, such as flamprop-methyl or flamprop-isopropyl; p-hydroxyphenylpyruvat-dioxygenase (HPPD)-inhibitors, for example pyrazolynate, pyrazoxyfen, benzofenap, sulcotrione, isoxaflutole, mesotrione, isoxachlortole, ketospiradox, tembotrione; acetolactate synthase inhibitors (ALS), for example imidazolinones, such as imazapyr, imazaquin, imazamethabenz-methyl (imazame), imazamox, imazapic or imazethapyr; pyrimidyl ethers, such as pyrithiobac-acid, pyrithiobac-sodium, bispyribac-sodium or pyribenzoxym; sulfonamides, such as cloransulam, diclosulam, florasulam, flumetsulam, metosulam or penoxsulam; or sulfonylureas, such as amidosulfuron, azimsulfuron, bensulfuron-methyl, chlorimuronethyl, chlorsulfuron, cinosulfuron, cyclosulfamuron, ethametsulfuron-methyl, ethoxysulfuron, flazasulfuron, foramsulfuron, halosulfuron-methyl, imazosulfuron, iodosulfuron, metsulfuron-methyl, nicosulfuron, primisulfuron-methyl, prosulfuron, pyrazosulfuronethyl, rimsulfuron, sulfometuron-methyl or -3-oxetanyl, sulfosulfuron, thifensulfuron-methyl, triasulfuron, tribenuron-methyl, triflusulfuron-methyl or tritosulfuron; amides, for example allidochlor, benzoylprop-ethyl, bromobutide, chlorthiamid, diphenamid, etobenzanid (benzchlomet), fluthiamide, fosamin or monalide; auxin herbicides, for example pyridinecarboxylic acids, such as clopyralid or picloram; 2,4-D or benazolin; auxin transport inhibitors, for example naptalame or diflufenzopyr; carotenoid biosynthesis inhibitors, for example amitrol, diflufenican, fluorochloridone, fluridone, flurtamone, norflurazon or picolinafen; enolpyruvylshikimate-3-phosphate synthase inhibitors (EPSPS), for example glyphosate or sulfosate; glutamine synthetase inhibitors, for example bilanafos (bialaphos) or glufosinate-ammonium; lipid biosynthesis inhibitors, for example anilides, such as anilofos or mefenacet; chloroacetanilides, such as dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor or xylachlor; thioureas, such as butylate, cycloate, di-allate, dimepiperate, EPTC, esprocarb, molinate, pebulate, prosulfocarb, thiobencarb (benthiocarb), tri-allate or vernolate; or benfuresate or perfluidone; mitosis inhibitors, for example carbamates, such as asulam, carbetamid, chlorpropham, orbencarb, propyzamid, propham or tiocarbazil; dinitroanilines, such as benefin, butralin, dinitramin, ethalfluralin, fluchloralin, oryzalin, pendimethalin, prodiamine or trifluralin; pyridines, such as dithiopyr or thiazopyr; or butamifos, chlorthal-dimethyl (DCPA) or maleic hydrazide; protoporphyrinogen IX oxidase inhibitors, for example diphenyl ethers, such as acifluorfen, acifluorfen-sodium, aclonifen, bifenox, chlornitrofen (CNP), ethoxyfen, fluorodifen, fluoroglycofen-ethyl, fomesafen, furyloxyfen, lactofen, nitrofen, nitrofluorfen or oxyfluorfen; oxadiazoles, such as oxadiargyl or oxadiazon; cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin; or pyrazoles, such as ET-751, JV 485 or nipyraclofen; photosynthesis inhibitors, for example propanil, pyridate or pyridafol; benzothiadiazinones, such as bentazone; dinitrophenols, for example bromofenoxim, dinoseb, dinoseb-acetate, dinoterb or DNOC; dipyridylenes, such as cyperquat-chloride, difenzoquat-methylsulfate, diquat or paraquat-dichloride; ureas, such as chlorbromuron, chlorotoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron; phenols, such as bromoxynil or ioxynil; chloridazon; triazines, such as ametryn, atrazine, cyanazine, desmetryn, dimethamethryn, hexazinone, prometon, prometryn, propazine, simazine, simetryn, terbumeton, terbutryn, terbutylazine or trietazine; triazinones, such as metamitron or metribuzin; uracils, such as bromacil, lenacil or terbacil; or biscarbamates, such as desmedipham or phenmedipham; growth substances, for example aryloxyalkanoic acids, such as 2,4-DB, clomeprop, dichlorprop, dichlorprop-P (2,4-DP-P), fluoroxypyr, MCPA, MCPB, mecoprop, mecoprop-P or triclopyr; benzoic acids, such as chloramben or dicamba; or quinolinecarboxylic acids, such as quinclorac or quinmerac; cell wall synthesis inhibitors, for example isoxaben or dichlobenil; various other herbicides, for example dichloropropionic acids, such as dalapon; dihydrobenzofurans, such as ethofumesate; henylacetic acids, such as chlorfenac (fenac); or aziprotryn, barban, bensulide, benzthiazuron, benzofluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon; or their environmentally compatible salts, “acids”, esters and amides.

In some particular embodiments, the synergistic mixture further comprises beflubutamid or beflubutamid-M.

Bixlozone and pethoxamid and optionally one or more additional herbicides may also be applied in combination with at least one safener compound. A safener compound is a compound, which is effective for antagonism of bixlozone and pethoxamid or both or the optional additional herbicide(s), and which is applied in a suitable amount i.e., an amount which counteracts to some degree a phytotoxic response of a useful plant to the herbicide(s). The safener may suitably be incorporated in the agrochemical composition. Safeners suitable for use include cloquintocet, cloquintocet-mexyl, benoxacor, dichlormid, fenchlorazole-ethyl, fenclorim, flurazole, fluxofenim, furilazole, isoxadifen, isoxadifen-ethyl, mefenpyr, mefenpyr-diethyl and oxabetrinil or their environmentally compatible salts, “acids”, esters and amides.

In some embodiments, the agrochemical composition further comprises a safener selected from quinolinecarboxylic acid herbicides and agriculturally acceptable salts and esters thereof, cloquintocet mexyl, cyprosulfamide, mefenpyr, mefenpyr-diethyl, and combinations thereof.

Generally, the agrochemical compositions according to the present disclosure may be prepared according to suitable methods known in the art. In some embodiments, the agrochemical compositions according to the present disclosure are prepared according to a method comprising forming a mixture comprising (i) bixlozone and (ii) pethoxamid, wherein the bixlozone and the pethoxamid are present in synergistically effective amounts, and wherein the bixlozone and the pethoxamid are present in a ratio in the range of from about 1.25:1 to about 1:8.

Generally, the agrochemical compositions according to the present disclosure may be used according to suitable methods known in the art. In some embodiments, the agrochemical compositions according to the present disclosure are used according to a method comprising applying to undesirable vegetation or to a locus thereof or applying to a soil to prevent an emergence or growth of the undesirable vegetation an agrochemical composition comprising bixlozone and pethoxamid, wherein the bixlozone and the pethoxamid are present in synergistically effective amounts, and wherein the bixlozone and the pethoxamid are present in a ratio of bixlozone:pethoxamid in the range of from about 1.25:1 to about 1:8.

In some embodiments, the vegetation comprises at least one herbicide resistant or tolerant weed species. In some embodiments, the vegetation comprises at least one susceptible weed species.

In some embodiments, the vegetation comprises a weed selected from a broad leaf weed and a grass weed.

In some embodiments, the agrochemical composition is applied at a stage selected from pre-emergence, post-emergence, and combinations thereof.

The agrochemical compositions according to the present disclosure can be employed for the selective control of grasses and annual and perennial monocotyledonous and dicotyledonous harmful plants the presence of useful plants such as maize, soya, peas, beans, sunflowers, oilseed rape, sugar cane, cassava, pumpkins, potatoes, vegetables and tobacco. Within the scope of this invention is also the control of such harmful plants found among transgenic useful plants or among useful plants selected by classical means which are resistant to bixlozone and/or pethoxamid. Likewise, the agrochemical compositions can be employed for controlling undesirable harmful plants in plantation crops.

Among harmful plants, e.g., weeds or volunteer crop plants, that may be controlled are Abutilon theophrasti (ABUTH), Acalypha virginica (ACCVI), Alopecurus myosuroides (ALOMY), Amaranthus retroflexus (AMARE), Ambrosia artemisiifolia (AMBEL), Anagallis arvensis (ANGAR), Apera spica-venti (APESV), Arrhenatherum elatius (ARREB), Calystegia sepium (CAGSE), Capsella bursa-pastoris (CAPBP), Centaurea cyanus (CENCY), Chenopodium album (CHEAL), Chenopodium hybridum (CHEHY), Chenopodium polyspermum (CHEPO), Cirsium arvense (GIRAR), Convolvulus arvensis (CONAR), Cynodon dactylon (CYNDA), Cyperus difformis (CYPDI), Cyperus iria (CYPIR), Datura stramonium (DATST), Daucus carota (DAUCA), Descurainia sophia (DESSO), Digitaria sanguinalis (DIGSA), Echinochloa crus-galli (ECHCG), Echinochloa colonum (ECHCO), Fumaria officinalis (FUMOF), Galium aparine (GALAP), Galinsoga quadriradiata (GASCI), Geranium dissectum (GERDI), Geranium mole (GERMO), Geranium pusillum (GERPU), Hibiscus trionum (HIBTR), Lamium amplexicaule (LAMAM), Lamium purpureum (LAMPU), Buglossoides arvensis (LITAR), Lolium multiflorum (LOLMU), Lolium perenne (LOLPE), Lolium rigidum (LOLRI), Matricaria chamomilla (MATCH), Tripleurospermum inodorum (MATIN), Mercurialis annua (MERAN), Panicum dichotomiflorum (PANDI), Panicum miliaceum (PAPRS), Papaver rhoeas (PAPRH), Phalaris minor (PHAMI), Poa annua (POAAN), Polygonum aviculare (POLAV), Fallopia convolvulus (POLCO), Persicaria hydropiper (POLHY), Persicaria lapathifolia (POLLA), Persicaria maculosa (POLPE), Portulaca oleracea (POROL), Potentilla tridentate (PTLTR), Senecio vulgaris (SENVU), Setaria pumila (SETPU), Setaria viridis (SETVI), Solanum nigrum (SOLNI), Sorghum halepense (SORHA), Stellaria media (STEME), Trifolium incarnatum (TRFIN), Veronica arvensis (VERAR), Veronica hederifolia (VERHE), Veronica persica (VERPE), Viola arvensis (VIOAR), and Xanthium strumarium (XANST), and combinations thereof.

Also among harmful plants, e.g., weeds or volunteer crop plants, that may be controlled are Digitaria ischaemum, Matricaria spp., Myosotis arvensis, Poa spp., Polygonum convolvulus, Polygonum persicaria, Portulaca oleracea, and Setaria geniculate.

Also among harmful plants, e.g., weeds or volunteer crop plants, that may be controlled are annual blue grass, annual ryegrass (Lolium rigidum), ball medic (Medicago spp.), barley grass (Hordeum murinum), bedstraw (Galium tricornutum), Benghal dayflower, bifora (Bifora testiculata), black grass, black night shade, broadleaf signal grass, brome grass (Bromus spp.), Canada thistle, capeweed (Arctotheca calendula), cheat, chickweed (Stellaria media), common cocklebur (Xanthium pensylvanicum), common ragweed, corn poppies, doublegee (Emex australis), field violet, fleabane (Conyza bonariensis) giant foxtail, fumitory (Fumaria spp), goose grass, green fox tail, guinea grass, hairy beggarticks, herbicide-resistant black grass, horseweed, Indian hedge mustard (Sisymbrium orientale), Italian rye grass, Jersey cudweed (Gnaphalium luteoalbum), jimsonweed, johnsongrass (Sorghum halepense), large crabgrass, lesser loosestrife (Lythrum hyssopifolia), little seed cany grass, morning glory, Patterson's Curse (Echium plantagineum), Pennsylvania smartweed, phalaris (Phalaris paradoxa), pitted morning glory, prickly lettuce (Lactuca serriola), prickly sida, quack grass, redflowered mallow (Modiola caroliniana), redroot pigweed, rough poppy (Papaver hybridum), serradella, shatter cane, shepherd's purse, silky windgrass, silvergrass (Vulpia bromoides), sowthistle (Sonchus oleraceus), sub-clover (Trifolium spp.), sunflower (as weed in potato), volunteer chickpea, faba beans, field peas, lentils, lupins and vetch, wild buckwheat (Polygonum convolvulus), wild mustard (Brassica kaber), wild oat (Avena fatua), wild pointsettia, wild radish (Raphanus raphanistrum), wild turnip (Rapistrum rugosum, Brassica tournefortii), wireweed (Polygonum aviculare), yellow foxtail, and yellow nutsedge (Cyperus esculentus).

Preferred harmful plants, e.g., weeds or volunteer crop plants, that may be controlled are wild radish (Raphanus raphanistrum), velvetleaf, jimsonweed, common cocklebur, and hairy beggarticks. Especially preferred harmful plants, e.g., weeds or volunteer crop plants, that may be controlled are wild radish (Raphanus raphanistrum).

### EXAMPLES

### Synergy.

A synergistic effect exists whenever the action of a combination of active components is greater than the sum of the action of each of the components alone. Therefore, a synergistic combination is a combination of active components having an action that is greater than the sum of the action of each active component alone, and a synergistically effective amount is an effective amount of a synergistic combination. Well-known methods for determining whether synergy exists include the Colby method, the Tammes method and the Wadley method, all of which are described below. Any one of these methods may be used to determine if synergy exists between compounds A and B.

In the Colby method, also referred to as the Limpels method, the action to be expected E for a given active ingredient combination obeys the so-called Colby formula. According to Colby, the expected action of active ingredients A+B using p+q ppm of active ingredient is:

$$E = X + Y - \frac{X \cdot Y}{100}$$

where ppm=milligrams of active ingredient (=a.i.) per liter of spray mixture X=% action by component A using p ppm of active ingredient Y=% action by component B using q ppm of active ingredient. If the ratio R defined as the action actually observed (O) divided by the expected action (E) is >1 then the action of the combination is superadditive, i.e. there is a synergistic effect. For a more detailed description of the Colby formula, see Colby, S. R. “Calculating Synergistic and Antagonistic Responses of Herbicide Combination”, Weeds, Vol. 15, pages 20-22; 1967; see also Limpel et al., Proc. NEWCC 16:48-53 (1962).

The Tammes method uses a graphic representation to determine whether a synergistic effect exists. See “Isoboles, a graphic representation of synergism in pesticides,” Netherlands Journal of Plant Pathology, 70 (1964) p. 73-80.

The Wadley method is based on comparison of an observed EC50 value (i.e. concentration providing 50% control) obtained from experimental data using the dose response curves and an expected EC50 calculated theoretically from the formula:

$$EC 50 {( A + B )}_{exp} = \frac{a + b}{\frac{a}{EC 50 {( A )}_{obs}} + \frac{b}{EC 50 {( B )}_{obs}}}$$

wherein a and b are the weight ratios of compound A and B in the mixture and EC50_{obs} is the experimentally determined EC50 value obtained using the dose response curves for the individual compounds. The ratio EC50(A+B)_{expected}/EC50(A+B)_{observed} expresses the factor of interaction (F) (synergy factor). In the case of synergism, F is >1. For a more detailed description of the Wadley method, see Levi et al., EPPO-Bulletin 16, 1986, 651-657.

The invention is illustrated by the following examples.

As used herein, rating timings correspond to the following: A1=weed assessment at BBCH 11-12; A2=4 weeks after the application; A3=when ZEAMX crop reaches BBCH 18 (row closure); and A4=BBCH 51-59 of the ZEAMX crop.

The herbicidal compounds bixlozone and pethoxamid were applied in a variety of forms and at a variety of amounts, application rates, and normalities. Efficacy of the herbicidal compositions was evaluated with reference to a scale of 0% to 100% in comparison with untreated control plots. 0 means no damage to the harmful plants and 100 means complete destruction of the harmful plants. Plants per square meter is indicated by “pl/m²”, and grams per hectare is indicated by “g/ha”. The acronym “EC” means emulsifiable concentrate (a liquid, homogenous formulation to be applied as an emulsion after dilution with water); “SC” means suspension concentrate (a stable suspension of active ingredient(s) with water as the fluid); “ZC” refers to a mixed formulation of CS and SC (a stable suspension of capsules and active ingredient(s) in a fluid, normally intended for dilution with water before use).

### Example 1. Pre-Emergence Application of Agrochemical Mixtures on Corn for Grass Weeds

Various forms, compositions, and mixtures of bixlozone and pethoxamid were applied to corn before emergence. Acceptable crop safety was observed for all combinations. A bixlozone CS (250 g/ha)+pethoxamid CS tank mix provided additional crop safety equivalent to a tank mix having only bixlozone SC at a reduced rate (150 g/ha). There was equivalent efficacy for fixed rate of bixlozone combined with pethoxamid: 1200 or 900 g/ha. Efficacy was reduced when bixlozone rate decreased from 250 to 150 g/ha. Rate-for-rate efficacy was lower for bixlozone CS (250 g/ha)+pethoxamid CS tank mixes compared to bixlozone SC+pethoxamid EC.

Table 1. Efficacies of various forms and mixtures of bixlozone and pethoxamid after pre-emergence application on corn. Weeds were present at ≥5 pl/m². Concentrations are shown in parentheses in g/ha. Data were not collected where indicated with an entry of “−”.

| | Tank Mix | | | | |
|---|---|---|---|---|---|
| | bixlozone SC + | bixlozone CS + | bixlozone SC + | bixlozone SC + | bixlozone SC + |
| | pethoxamid EC | pethoxamid CS | pethoxamid EC | pethoxamid EC | pethoxamid EC |
| Weed | (250 + 1200) | (250 + 1200) | (250 + 900) | (150 + 1200) | (150 + 900) |
| PAPRS | 100 | 100 | 100 | 100 | 100 |
| LOLPE | 100 | — | 100 | 100 | 99 |
| CYNDA | 99 | 80 | 98 | 82 | 71 |
| ECHCG | 87 | 81 | 91 | 81 | 79 |
| DIGSA | 87 | 80 | 90 | 77 | 73 |
| SETVI | 83 | 71 | 85 | 80 | 80 |
| SETPU | 77 | 73 | 70 | 71 | 67 |
| SORHA | 42 | 41 | 37 | 30 | 33 |

### Example 2. Pre-Emergence Application of Agrochemical Mixtures on Corn for Broad Leaf Weeds

Various forms, compositions, and mixtures of bixlozone and pethoxamid were applied to corn before emergence. Acceptable crop safety was observed for all combinations. A bixlozone CS (250 g/ha)+pethoxamid CS tank mix provided additional crop safety equivalent to a tank mix having only bixlozone SC at a reduced rate (150 g/ha). There was equivalent efficacy for fixed rate of bixlozone combined with pethoxamid: 1200 or 900 g/ha. Efficacy was reduced when bixlozone rate decreased from 250 to 150 g/ha. Rate-for-rate efficacy was lower for bixlozone CS (250 g/ha)+pethoxamid CS tank mixes compared to bixlozone SC+pethoxamid EC.

Table 2. Efficacies of various forms and mixtures of bixlozone and pethoxamid after pre-emergence application on corn. Weeds were present at ≥5 pl/m². Concentrations are shown in parentheses in g/ha. Data were not collected where indicated with an entry of “−”.

| | Tank Mix | | | | |
|---|---|---|---|---|---|
| | bixlozone SC + | bixlozone CS + | bixlozone SC + | bixlozone SC + | bixlozone SC + |
| | pethoxamid EC | pethoxamid CS | pethoxamid EC | pethoxamid EC | pethoxamid EC |
| Weed | (250 + 1200) | (250 + 1200) | (250 + 900) | (150 + 1200) | (150 + 900) |
| ABUTH | 100 | — | 100 | 100 | 100 |
| AMARE | 100 | 99 | 100 | 99 | 100 |
| CAPBP | 100 | — | 100 | 100 | 99 |
| CHEAL | 100 | — | 100 | 100 | 99 |
| CONAR | 100 | — | 78 | 100 | 96 |
| DATST | 99 | 98 | 99 | 99 | 99 |
| GASCI | 92 | 87 | 90 | 87 | 88 |
| HIBTR | 89 | — | 91 | 90 | 91 |
| LAMPU | 83 | 71 | 84 | 76 | 73 |
| MATCH | 82 | 74 | 76 | 74 | 75 |
| MERAN | 80 | 77 | 86 | 74 | 72 |
| POLCO | 79 | 70 | 79 | 72 | 58 |
| POLLA | 75 | 60 | 50 | 64 | 18 |
| POLPE | 75 | 73 | 83 | 76 | 71 |
| SENVU | 70 | 40 | 84 | 77 | 72 |
| SOLNI | 68 | — | 58 | 74 | 54 |
| STEME | 35 | 39 | 36 | 28 | 28 |
| VIOAR | 34 | 33 | 38 | 24 | 28 |
| XANST | 0 | 0 | 0 | 0 | 0 |

Table 3. Synergy data of various forms and mixtures of bixlozone and pethoxamid after pre-emergence application on corn. The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

| | | Synergistic Efficacy | | | |
|---|---|---|---|---|---|
| | | Colby | Obs-Exp | Colby | Obs-Exp |
| | Rating | (250SC + | (250SC + | (250SC + | (250SC + |
| Weed | Timing | 1200EC) | 1200EC; tank) | 900EC) | 900EC; tank) |
| ABUTH | A1 | 83.8 | 10.2 | 81.6 | 9.7 |
| ABUTH | A2 | 77.7 | 2.9 | 75.6 | 4.0 |
| ABUTH | A3 | 68.2 | 2.7 | 66.6 | 2.8 |
| ABUTH | A4 | 51.8 | 7.0 | 51.8 | 8.9 |
| AMARE | A1 | 95.0 | −1.0 | 93.1 | 0.9 |
| AMARE | A2 | 92.4 | −7.0 | 90.1 | −7.3 |
| AMARE | A3 | 87.9 | −8.3 | 86.3 | −0.6 |
| AMARE | A4 | 82.9 | −15.4 | 79.2 | −6.4 |
| CAPBP | A1 | 95.2 | 4.8 | 97.8 | 2.2 |
| CAPBP | A2 | 99.5 | 0.5 | 99.4 | 0.6 |
| CAPBP | A3 | 99.1 | 0.7 | 99.2 | 0.8 |
| CAPBP | A4 | 99.0 | 1.0 | 99.0 | 1.0 |
| CHEAL | A1 | 71.3 | −7.6 | 68.6 | −1.6 |
| CHEAL | A2 | 87.1 | −7.8 | 85.8 | −4.8 |
| CHEAL | A3 | 82.1 | 1.0 | 81.1 | 2.6 |
| CHEAL | A4 | 78.9 | 0.2 | 77.8 | 1.3 |
| CHEHY | A4 | 100.0 | −2.5 | 99.5 | 0.5 |
| GIRAR | A2 | 99.4 | 0.6 | 99.0 | −1.5 |
| CONAR | A2 | 94.9 | −6.8 | 90.7 | −16.3 |
| CONAR | A3 | 89.9 | −19.9 | 87.6 | −4.1 |
| CONAR | A4 | 91.2 | −19.9 | 86.7 | −16.8 |
| CONAR | A1 | 94.0 | −9.0 | 92.5 | −12.5 |
| DATST | A1 | 83.4 | −0.3 | 85.9 | −15.6 |
| DATST | A2 | 65.0 | 16.3 | 65.0 | 2.5 |
| DATST | A3 | 61.3 | 13.7 | 61.3 | −11.3 |
| DATST | A4 | 67.5 | 12.5 | 67.5 | −52.5 |
| DIGSA | A3 | 90.2 | −3.6 | 87.6 | 2.1 |
| DIGSA | A4 | 82.7 | −3.9 | 79.5 | 5.9 |
| DIGSA | A1 | 94.7 | −2.6 | 95.6 | −1.6 |
| DIGSA | A2 | 98.1 | −5.8 | 97.6 | −3.2 |
| ECHCG | A1 | 92.7 | −12.3 | 89.4 | −8.3 |
| ECHCG | A2 | 90.9 | −13.1 | 87.8 | −6.7 |
| ECHCG | A3 | 94.0 | −6.7 | 92.1 | −0.9 |
| ECHCG | A4 | 91.3 | −7.3 | 89.2 | −2.1 |
| GASCI | A3 | 100.0 | 0.0 | 100.0 | −0.2 |
| GASCI | A4 | 100.0 | 0.0 | 100.0 | 0.0 |
| GERDI | A2 | 99.6 | −10.8 | 99.8 | −7.3 |
| LAMPU | A1 | 94.5 | 5.5 | 95.2 | 4.8 |
| LAMPU | A2 | 99.8 | 0.3 | 99.7 | 0.3 |
| LAMPU | A3 | 99.8 | 0.0 | 99.8 | 0.2 |
| LAMPU | A4 | 99.8 | 0.2 | 99.8 | 0.2 |
| LOLPE | A1 | 99.9 | 0.1 | 100.0 | 0.0 |
| LOLPE | A2 | 100.0 | 0.0 | 100.0 | 0.0 |
| LOLPE | A3 | 100.0 | −0.2 | 100.0 | 0.0 |
| LOLPE | A4 | 100.0 | 0.0 | 100.0 | 0.0 |
| MATCH | A1 | 100.0 | 0.0 | 99.8 | 0.2 |
| MATCH | A2 | 99.2 | 0.8 | 98.8 | 1.2 |
| MATCH | A3 | 98.6 | 1.2 | 99.0 | −21.5 |
| MATCH | A4 | 98.6 | 1.4 | 98.8 | 1.2 |
| MERAN | A2 | 99.5 | −2.1 | 99.5 | −4.1 |
| MERAN | A3 | 96.3 | −4.5 | 95.8 | −6.1 |
| MERAN | A4 | 99.3 | −2.8 | 98.9 | −3.4 |
| MERAN | A1 | 98.4 | −0.4 | 98.2 | −3.2 |
| PAPRS | A1 | 100.0 | 0.0 | 100.0 | 0.0 |
| PAPRS | A2 | 100.0 | 0.0 | 100.0 | 0.0 |
| PAPRS | A3 | 100.0 | 0.0 | 100.0 | 0.0 |
| PAPRS | A4 | 99.6 | 0.4 | 99.0 | 1.0 |
| POLCO | A2 | 92.9 | −7.9 | 93.6 | −8.6 |
| POLCO | A3 | 83.1 | −8.1 | 86.9 | −4.4 |
| POLCO | A4 | 53.0 | 9.5 | 54.5 | 8.0 |
| POLLA | A1 | 0.0 | 0.0 | 0.0 | 0.0 |
| POLLA | A2 | 99.3 | −0.5 | 97.4 | −1.1 |
| POLLA | A3 | 99.0 | −0.2 | 97.7 | 1.1 |
| POLLA | A4 | 97.0 | 1.0 | 92.7 | 1.6 |
| POLPE | A1 | 93.4 | −0.4 | 90.3 | −5.5 |
| POLPE | A2 | 92.3 | −5.9 | 90.9 | −14.0 |
| POLPE | A3 | 88.5 | −6.9 | 85.9 | −10.4 |
| POLPE | A4 | 79.8 | −7.2 | 75.0 | −6.0 |
| RUMOB | A4 | 98.8 | −27.5 | 99.8 | −7.3 |
| SENVU | A2 | 99.1 | −3.2 | 99.1 | −1.8 |
| SENVU | A3 | 91.1 | −2.3 | 94.4 | −3.1 |
| SENVU | A4 | 97.7 | −5.8 | 96.9 | −2.5 |
| SETPU | A3 | 77.3 | −0.3 | 66.2 | 3.8 |
| SETPU | A4 | 69.6 | 2.5 | 59.9 | 6.7 |
| SETPU | A2 | 77.4 | −13.6 | 64.9 | −9.9 |
| SETVI | A2 | 96.6 | −7.2 | 95.6 | −8.1 |
| SETVI | A3 | 94.9 | −11.8 | 94.1 | −9.1 |
| SETVI | A4 | 89.8 | −9.4 | 89.0 | −8.4 |
| SETVI | A1 | 94.0 | −4.0 | 91.0 | −6.0 |
| SOLNI | A1 | 77.9 | −9.2 | 74.9 | −6.6 |
| SOLNI | A2 | 86.0 | −3.1 | 83.5 | −3.5 |
| SOLNI | A3 | 76.3 | 2.2 | 74.4 | 4.4 |
| SOLNI | A4 | 77.9 | −1.4 | 76.6 | −2.2 |
| SORHA | A1 | 74.4 | −34.4 | 68.2 | −29.1 |
| SORHA | A2 | 59.7 | −21.7 | 53.2 | −22.2 |
| SORHA | A3 | 59.1 | −17.6 | 53.1 | −16.1 |
| SORHA | A4 | 41.1 | −12.6 | 30.6 | −2.6 |
| STEME | A1 | 99.4 | −0.6 | 99.7 | −0.4 |
| STEME | A2 | 99.8 | 0.0 | 99.8 | 0.0 |
| STEME | A3 | 100.0 | 0.0 | 100.0 | 0.0 |
| STEME | A4 | 98.6 | 0.9 | 98.8 | 0.7 |
| TRFAR | A2 | 99.7 | −2.2 | 99.8 | −3.5 |
| VIOAR | A1 | 27.8 | −6.5 | 27.8 | −10.3 |
| VIOAR | A2 | 57.3 | −11.5 | 52.8 | −11.3 |
| VIOAR | A3 | 75.1 | −6.8 | 68.5 | −10.5 |
| VIOAR | A4 | 84.4 | −8.1 | 80.3 | −9.8 |
| XANST | A2 | 41.3 | −2.5 | 41.3 | −2.5 |
| XANST | A3 | 33.8 | 0.0 | 33.8 | 3.7 |
| XANST | A4 | 21.3 | −1.3 | 21.3 | 6.2 |

Table 4. Synergy data of various forms and mixtures of bixlozone and pethoxamid after pre-emergence application on corn. The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

| | | Synergistic Efficacy | | | |
|---|---|---|---|---|---|
| | | Colby | Obs-Exp | Colby | Obs-Exp |
| | Rating | (150SC + | (150SC + | (150SC + | (150SC + |
| Weed | Timing | 1200EC) | 1200EC; tank) | 900EC) | 900EC; tank) |
| ABUTH | A1 | 77.8 | 8.8 | 74.8 | 10.2 |
| ABUTH | A2 | 68.7 | 0.9 | 65.9 | 2.7 |
| ABUTH | A3 | 58.0 | −1.6 | 55.9 | 5.9 |
| ABUTH | A4 | 39.0 | 5.1 | 39.0 | 11.2 |
| AMARE | A1 | 91.0 | −6.0 | 87.6 | −1.3 |
| AMARE | A2 | 90.1 | −10.5 | 87.2 | −4.9 |
| AMARE | A3 | 82.4 | −8.1 | 80.2 | −8.1 |
| AMARE | A4 | 76.9 | −17.5 | 71.8 | 0.2 |
| CAPBP | A1 | 86.2 | 13.8 | 93.5 | 6.5 |
| CAPBP | A2 | 99.6 | 0.4 | 99.5 | 0.5 |
| CAPBP | A3 | 98.9 | 1.1 | 99.0 | 0.0 |
| CAPBP | A4 | 98.7 | 1.3 | 98.7 | −1.2 |
| CHEAL | A1 | 64.1 | −3.5 | 60.8 | 0.2 |
| CHEAL | A2 | 80.5 | −6.3 | 78.4 | −3.7 |
| CHEAL | A3 | 75.7 | 0.6 | 74.4 | −1.0 |
| CHEAL | A4 | 73.2 | −2.4 | 71.8 | −2.4 |
| CHEHY | A4 | 100.0 | −2.5 | 98.6 | 1.4 |
| GIRAR | A2 | 100.0 | −2.5 | 100.0 | 0.0 |
| CONAR | A2 | 96.1 | −9.5 | 92.9 | −14.4 |
| CONAR | A3 | 94.7 | −17.8 | 93.5 | −21.6 |
| CONAR | A4 | 94.2 | −27.3 | 91.2 | −19.7 |
| CONAR | A1 | 95.3 | −16.5 | 94.1 | −26.6 |
| DATST | A1 | 61.7 | 6.2 | 67.6 | −7.0 |
| DATST | A2 | 15.0 | 60.0 | 15.0 | 25.0 |
| DATST | A3 | 0.0 | 63.8 | 0.0 | 17.5 |
| DATST | A4 | 0.0 | 65.0 | 0.0 | 0.0 |
| DIGSA | A3 | 84.8 | −8.0 | 80.9 | −8.2 |
| DIGSA | A4 | 71.5 | −4.8 | 66.2 | 1.1 |
| DIGSA | A1 | 91.7 | −4.7 | 93.1 | −4.6 |
| DIGSA | A2 | 94.5 | −6.1 | 93.0 | −2.9 |
| ECHCG | A1 | 90.2 | −13.9 | 85.8 | −12.2 |
| ECHCG | A2 | 87.1 | −13.1 | 82.8 | −11.0 |
| ECHCG | A3 | 90.9 | −9.5 | 88.0 | −9.2 |
| ECHCG | A4 | 86.6 | −7.7 | 83.3 | −8.6 |
| GASCI | A3 | 100.0 | 0.0 | 100.0 | −0.2 |
| GASCI | A4 | 100.0 | 0.0 | 100.0 | 0.0 |
| GERDI | A2 | 99.5 | −7.0 | 99.7 | −3.4 |
| LAMPU | A1 | 97.0 | 3.0 | 97.4 | 2.6 |
| LAMPU | A2 | 99.7 | 0.3 | 99.7 | 0.3 |
| LAMPU | A3 | 99.7 | 0.3 | 99.7 | −0.7 |
| LAMPU | A4 | 99.6 | 0.4 | 99.6 | 0.2 |
| LOLPE | A1 | 99.9 | 0.1 | 100.0 | 0.0 |
| LOLPE | A2 | 100.0 | 0.0 | 100.0 | 0.0 |
| LOLPE | A3 | 100.0 | 0.0 | 100.0 | −1.0 |
| LOLPE | A4 | 99.9 | 0.1 | 100.0 | 0.0 |
| MATCH | A1 | 99.6 | 0.4 | 92.6 | 7.4 |
| MATCH | A2 | 99.0 | 1.0 | 98.5 | 1.5 |
| MATCH | A3 | 98.4 | 1.6 | 98.8 | −2.8 |
| MATCH | A4 | 98.5 | 1.5 | 98.7 | −4.9 |
| MERAN | A2 | 98.2 | −4.8 | 98.1 | −2.6 |
| MERAN | A3 | 95.3 | −8.0 | 94.7 | −7.1 |
| MERAN | A4 | 99.4 | −5.4 | 99. | −5.6 |
| MERAN | A1 | 88.0 | 2.0 | 86.5 | 8.5 |
| PAPRS | A1 | 100.0 | 0.0 | 100.0 | 0.0 |
| PAPRS | A2 | 100.0 | 0.0 | 100.0 | 0.0 |
| PAPRS | A3 | 100.0 | 0.0 | 100.0 | 0.0 |
| PAPRS | A4 | 100.0 | 0.0 | 100.0 | 0.0 |
| POLCO | A2 | 86.5 | −5.2 | 88.0 | −11.7 |
| POLCO | A3 | 80.3 | −4.0 | 84.7 | −13.4 |
| POLCO | A4 | 38.0 | 10.8 | 39.9 | −24.9 |
| POLLA | A1 | 0.0 | 0.0 | 0.0 | 0.0 |
| POLLA | A2 | 99.1 | −1.1 | 96.7 | −2.4 |
| POLLA | A3 | 97.8 | 1.0 | 94.8 | 4.0 |
| POLLA | A4 | 93.5 | 0.3 | 84.2 | 10.8 |
| POLPE | A1 | 90.9 | −5.6 | 86.7 | −8.9 |
| POLPE | A2 | 87.2 | −9.8 | 84.8 | −4.5 |
| POLPE | A3 | 82.8 | −8.8 | 78.9 | −4.1 |
| POLPE | A4 | 69.9 | −4.7 | 62.9 | −1.7 |
| RUMOB | A4 | 99.6 | −6.1 | 99.9 | −1.1 |
| SENVU | A2 | 99.7 | −2.8 | 99.7 | −3.4 |
| SENVU | A3 | 97.3 | −7.3 | 98.3 | −7.0 |
| SENVU | A4 | 99.2 | −9.2 | 99.0 | −5.9 |
| SETPU | A3 | 75.5 | −4.2 | 63.5 | 3.9 |
| SETPU | A4 | 69.0 | −0.9 | 59.0 | 6.0 |
| SETPU | A2 | 65.6 | −1.8 | 46.6 | −0.3 |
| SETVI | A2 | 95.4 | −11.0 | 94.2 | −10.9 |
| SETVI | A3 | 93.3 | −13.3 | 92.3 | −12.3 |
| SETVI | A4 | 88.8 | −16.2 | 87.9 | −12.0 |
| SETVI | A1 | 92.0 | −12.0 | 88.0 | −13.0 |
| SOLNI | A1 | 72.7 | −6.0 | 69.1 | −9.9 |
| SOLNI | A2 | 80.1 | −2.3 | 76.6 | −6.3 |
| SOLNI | A3 | 67.8 | 4.0 | 65.2 | −7.4 |
| SOLNI | A4 | 71.0 | −3.9 | 69.2 | −10.9 |
| SORHA | A1 | 69.0 | −36.5 | 61.5 | −31.8 |
| SORHA | A2 | 50.3 | −27.3 | 42.3 | −18.8 |
| SORHA | A3 | 52.3 | −22.3 | 45.3 | −12.3 |
| SORHA | A4 | 35.0 | −14.5 | 23.5 | −4.7 |
| STEME | A1 | 88.8 | 9.5 | 93.7 | 4.6 |
| STEME | A2 | 99.8 | −1.0 | 99.8 | −0.3 |
| STEME | A3 | 98.9 | −0.1 | 98.9 | 0.6 |
| STEME | A4 | 99.5 | 0.5 | 99.6 | −2.6 |
| TRFAR | A2 | 99.7 | −2.2 | 99.8 | −3.5 |
| VIOAR | A1 | 21.6 | 2.9 | 21.6 | −9.1 |
| VIOAR | A2 | 48.8 | 1.0 | 43.4 | −10.4 |
| VIOAR | A3 | 67.2 | 6.8 | 58.6 | −4.6 |
| VIOAR | A4 | 80.0 | 0.0 | 74.7 | −6.4 |
| XANST | A2 | 31.3 | 2.5 | 31.3 | 1.2 |
| XANST | A3 | 22.5 | 1.3 | 22.5 | 5.0 |
| XANST | A4 | 15.0 | 2.5 | 15.0 | 6.3 |

Table 5. Synergy data of various forms and mixtures of bixlozone and pethoxamid after pre-emergence application on corn for all combined weeds. The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

| | Synergistic Efficacy | | | | | | | |
|---|---|---|---|---|---|---|---|---|
| | | Obs-Exp | | Obs-Exp | | Obs-Exp | | Obs-Exp |
| | Colby | (250SC + | Colby | (250SC + | Colby | (150SC + | Colby | (150SC + |
| Rating | (250SC + | 1200EC; | (250SC + | 900EC; | (150SC + | 1200EC; | (150SC + | 900EC; |
| Timing | 1200EC) | tank) | 900EC) | tank) | 1200EC) | tank) | 900EC) | tank) |
| A1 | 84.2 | −7.7 | 83.3 | −7.6 | 79.8 | −7.2 | 78.6 | −8.6 |
| A2 | 89.8 | −8.6 | 88.4 | −8.7 | 84.8 | −7.7 | 82.6 | −7.7 |
| A3 | 87.0 | −6.6 | 85.6 | −5.3 | 82.6 | −7.7 | 80.6 | −8.9 |
| A4 | 83.6 | −7.3 | 81.9 | −5.8 | 78.6 | −8.2 | 76.4 | −8.1 |

Table 6. Synergy data of various forms and mixtures of bixlozone and pethoxamid after pre-emergence application on corn for all combined grasses. The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

| | Synergistic Efficacy | | | | | | | |
|---|---|---|---|---|---|---|---|---|
| | | Obs-Exp | | Obs-Exp | | Obs-Exp | | Obs-Exp |
| | Colby | (250SC + | Colby | (250SC + | Colby | (150SC + | Colby | (150SC + |
| Rating | (250SC + | 1200EC; | (250SC + | 900EC; | (150SC + | 1200EC; | (150SC + | 900EC; |
| Timing | 1200EC) | tank) | 900EC) | tank) | 1200EC) | tank) | 900EC) | tank) |
| A1 | 94.0 | −7.0 | 93.1 | −5.6 | 91.7 | −8.5 | 90.4 | −8.5 |
| A2 | 95.4 | −9.4 | 93.9 | −7.2 | 91.8 | −8.2 | 89.1 | −8.1 |
| A3 | 94.3 | −6.5 | 92.4 | −3.0 | 92.0 | −9.6 | 89.2 | −8.9 |
| A4 | 89.7 | −6.4 | 87.6 | −2.2 | 85.9 | −8.7 | 82.9 | −6.3 |

Table 7. Synergy data of various forms and mixtures of bixlozone and pethoxamid after pre-emergence application on corn for all combined broad leaf weeds. The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

| | Synergistic Efficacy | | | | | | | |
|---|---|---|---|---|---|---|---|---|
| | | Obs-Exp | | Obs-Exp | | Obs-Exp | | Obs-Exp |
| | Colby | (250SC + | Colby | (250SC + | Colby | (150SC + | Colby | (150SC + |
| Rating | (250SC + | 1200EC; | (250SC + | 900EC; | (150SC + | 1200EC; | (150SC + | 900EC; |
| Timing | 1200EC) | tank) | 900EC) | tank) | 1200EC) | tank) | 900EC) | tank) |
| A1 | 78.5 | −2.6 | 78.1 | −4.6 | 71.5 | −0.8 | 70.9 | −3.5 |
| A2 | 85.9 | −5.7 | 84.5 | −7.0 | 79.9 | −4.1 | 77.9 | −5.8 |
| A3 | 81.8 | −3.4 | 80.7 | −3.2 | 75.7 | −2.3 | 74.3 | −6.3 |
| A4 | 79.0 | −3.8 | 77.7 | −5.5 | 72.1 | −4.1 | 70.3 | −5.9 |

### Example 3. Pre-Emergence Application of Agrochemical Mixtures on Corn at Relatively High Application Rates of Pethoxamid

Various forms, compositions, and mixtures of bixlozone and pethoxamid were applied to corn before emergence. For compositions of bixlozone only, minimal differences in performance between SC and CS were observed, except on CHEAL and ECHCG. Mixtures of bixlozone with 1200 g/ha pethoxamid improved weed spectrum on a range of broad leaf weeds (e.g., CHEAL, MATSS, and POLSS) and grasses (e.g., ECHCG, DIGSA, and SETVI). Combinations of bixlozone and pethoxamid in pre-emergence applications were very safe with no clear pethoxamid rate effect. Tank mixes and premixes yielded comparable efficacies.

Table 8. Efficacies of various forms and mixtures of bixlozone and pethoxamid after pre-emergence application on corn. Weeds were present at ≥5 pl/m². Concentrations are shown in parentheses in g/ha.

| | Tank Mix | | | | | Premix |
|---|---|---|---|---|---|---|
| | | | | bixlozone | bixlozone | bixlozone + |
| | bixlozone | bixlozone | | SC + | CS + | pethoxamid |
| | SC | CS | pethoxamid | pethoxamid | pethoxamid | mixed-CS |
| Weed | (375) | (375) | (1200) | (375 + 1200) | (375 + 1200) | (375 + 1200) |
| MERAN | 100 | 100 | 48.6 | 100 | 100 | 100 |
| POLAV | 100 | 100 | 77.5 | 100 | 97.5 | 100 |
| MATCH | 92.8 | 86.3 | 77.5 | 98.5 | 98 | 97.5 |
| SOLNI | 89 | 86.2 | 76.5 | 91.7 | 91.4 | 94 |
| POROL | 87 | 90.1 | 94.6 | 98 | 96.9 | 97.8 |
| MATIN | 82.5 | 60 | 100 | 100 | 88.8 | 100 |
| POLPE | 82.4 | 77.5 | 62.5 | 95.5 | 90 | 86.7 |
| AMARE | 77.5 | 81.9 | 57.5 | 84 | 82.8 | 92.8 |
| CHEAL | 75.9 | 65.7 | 72.2 | 92.2 | 88.1 | 83.3 |
| ACCVI | 63.8 | 75 | 46.3 | 70 | 75 | 75 |
| POLLA | 60 | 57.5 | 87.8 | 98 | 96.3 | 85 |
| ABUTH | 55 | 61.3 | 56.3 | 75.6 | 66.3 | 76.3 |
| AMBEL | 55 | 10 | 7.5 | 75 | 58.8 | 45 |
| POLCO | 24.5 | 14.2 | 12.1 | 42.4 | 37.6 | 6.3 |
| CAGSE | 0 | 0 | 0 | 0 | 0 | 0 |
| PTLTR | 0 | 0 | 0 | 0 | 0 | 7.5 |
| PANDI | 92.3 | 93.5 | 84.8 | 95 | 96.3 | 92.4 |
| LOLMU | 92 | 72.5 | 78.8 | 95.5 | 97.5 | 88.8 |
| ECHCG | 86.9 | 83.3 | 85.5 | 97 | 96.8 | 96.2 |
| DIGSA | 81.8 | 79.3 | 82 | 94.8 | 94.2 | 93.9 |
| SETVI | 60.4 | 59.6 | 52.1 | 82.9 | 81.3 | 80 |
| SORHA | 32.5 | 27.5 | 27.5 | 45 | 42.5 | 51 |

Table 9. Synergy data of various forms and mixtures of bixlozone and pethoxamid after pre-emergence application on corn at the crop row closure stage (BBCH 18). The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

| | Synergistic Efficacy | | | | | |
|---|---|---|---|---|---|---|
| | | Obs-Exp | Obs-Exp | | Obs-Exp | Obs-Exp |
| | Colby | (SC375 + | (CS375 + | Colby | (CS375+ | (CS375 + |
| | (SC375 + | EC1200; | CS1200; | (CS375+ | EC1200; | CS1200; |
| Weed | EC1200) | tank) | premix) | EC1200) | tank) | premix) |
| ABUTH | 80.3 | −4.7 | −4.0 | 83.1 | −16.8 | −6.8 |
| ACCVI | 80.6 | −10.6 | −5.6 | 86.6 | −11.6 | −11.6 |
| ECHCG | 98.1 | −1.1 | −1.9 | 97.6 | −0.8 | −1.4 |
| LOLMU | 98.3 | −2.8 | −9.5 | 94.2 | 3.3 | −5.4 |
| MATCH | 98.4 | 0.1 | −0.9 | 96.9 | 1.1 | 0.6 |
| MATIN | 100.0 | 0.0 | 0.0 | 100.0 | −11.2 | 0.0 |
| MERAN | 100.0 | 0.0 | 0.0 | 100.0 | 0.0 | 0.0 |
| PANDI | 98.8 | −3.8 | −6.4 | 99.0 | −2.7 | −6.6 |
| POLAV | 100.0 | 0.0 | 0.0 | 100.0 | −2.5 | 0.0 |
| POLCO | 33.6 | 8.8 | −27.3 | 24.6 | 13.0 | −18.3 |
| POLLA | 95.1 | 2.9 | −10.1 | 94.8 | 1.5 | −9.8 |
| POLPE | 93.4 | 2.1 | −6.7 | 91.6 | −1.6 | −4.9 |
| POROL | 99.3 | −1.3 | −1.5 | 99.5 | −2.6 | −1.7 |
| PTLTR | 0.0 | 0.0 | 7.5 | 0.0 | 0.0 | 7.5 |
| SETVI | 81.0 | 1.9 | −1.0 | 80.6 | 0.7 | −0.6 |
| SOLNI | 97.4 | −5.7 | −3.4 | 96.8 | −5.4 | −2.8 |
| SORHA | 51.1 | −6.1 | −0.1 | 47.4 | −4.9 | 3.6 |

Table 10. Synergy data of various forms and mixtures of bixlozone and pethoxamid after pre-emergence application on corn at the crop row closure stage (BBCH 18). The notations in parentheses show the forms of applied bixlozone and pethoxamid, respectively. The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

Synergistic Efficacy

| | | | Obs-Exp |
|---|---|---|---|
| | Colby | Obs-Exp | (375 + 800; |
| | (375CS + | (375CS + 800CS; | coCS; |
| Weed | 800EC) | premix) | premix) |
| ABUTH | 73.5 | −2.9 | −4.7 |
| AMARE | 79.3 | −14.6 | −7.2 |
| ANGAR | 100.0 | 0.0 | 0.0 |
| CAPBP | 100.0 | −0.5 | −2.5 |
| CHEAL | 88.7 | −16.8 | −16.5 |
| CHEPO | 65.0 | 15.0 | 0.0 |
| DIGSA | 84.6 | −12.9 | −20.8 |
| ECHCG | 91.9 | −11.5 | −11.3 |
| FUMOF | 12.5 | 6.3 | 8.8 |
| GALAP | 63.0 | −6.7 | −6.7 |
| MATCH | 100.0 | −2.5 | −5.0 |
| MERAN | 94.3 | −0.8 | −11.9 |
| PANDI | 94.5 | −1.5 | −0.7 |
| POLCO | 3.8 | 4.3 | 6.8 |
| POLLA | 99.0 | −28.0 | −22.7 |
| POLPE | 90.6 | −12.3 | −11.6 |
| POROL | 100.0 | −0.5 | −0.5 |
| SENVU | 34.3 | 23.2 | 0.7 |
| SETVI | 96.4 | −11.6 | −16.4 |
| STEME | 99.9 | −0.9 | −1.9 |

Table 11. Synergy data of various forms and mixtures of bixlozone and pethoxamid after pre-emergence application on corn at the crop row closure stage (BBCH 18). The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

Synergistic Efficacy

| | | | Obs-Exp |
|---|---|---|---|
| | Colby | Obs-Exp | (375 + 300; |
| | (375CS + | (375CS + 300CS; | co-CS; |
| Weed | 300EC) | premix) | premix) |
| ABUTH | 72.7 | 9.8 | 7.3 |
| ACCVI | 91.7 | −24.2 | −16.7 |
| CAGSE | 21.3 | 12.6 | −11.3 |
| CHEAL | 76.7 | −8.8 | −10.0 |
| CHEHY | 87.0 | −24.5 | 3.8 |
| DAUCA | 97.0 | −12.0 | −7.0 |
| LAMPU | 98.6 | −11.7 | −6.1 |
| MATCH | 98.8 | −1.3 | −1.3 |
| MATIN | 88.7 | 0.4 | −3.9 |
| MERAN | 86.9 | −4.6 | −7.2 |
| PANDI | 95.3 | −1.5 | −5.3 |
| POAAN | 98.0 | 0.0 | 0.3 |
| POLLA | 89.4 | −1.8 | −9.3 |
| POLPE | 96.7 | −1.9 | −5.2 |
| POROL | 98.4 | −0.3 | −0.1 |
| SETPU | 8.6 | 15.2 | −1.1 |
| SETVI | 87.4 | −5.5 | −4.4 |
| SOLNI | 71.7 | 9.1 | −4.8 |
| SORHA | 38.8 | −13.8 | −38.8 |
| VERPE | 100.0 | 0.0 | 0.0 |
| XANST | 64.3 | 0.8 | 10.8 |

### Example 4. Pre-Emergence Application of Agrochemical Mixtures on Corn at Relatively Medium Application Rates of Pethoxamid

Various forms, compositions, and mixtures of bixlozone and pethoxamid were applied to corn before emergence. For compositions of bixlozone only, minimal differences in performance between SC and CS were observed, except on CHEAL and ABUTH. Mixtures of bixlozone with 800 g/ha pethoxamid improved weed spectrum on a range of broad leaf weeds (e.g., CHEAL and ABUTH) and grasses (e.g., ECHCG, DIGSA, and SETVI). Combinations of bixlozone and pethoxamid in pre-emergence applications were very safe with no clear pethoxamid rate effect. Tank mixes and premixes yielded comparable efficacies. Compositions including bixlozone+pethoxamid mixed CS exhibited increased efficacy compared to compositions including bixlozone+pethoxamid co-encapsulated CS.

Table 12. Efficacies of various forms and mixtures of bixlozone and pethoxamid after pre-emergence application on corn. Weeds were present at ≥5 pl/m². Concentrations are shown in parentheses in g/ha.

| | Tank Mix | | | | Premix | |
|---|---|---|---|---|---|---|
| | | | | bixlozone | bixlozone + | bixlozone + |
| | bixlozone | bixlozone | | CS + | pethoxamid | pethoxamid |
| | SC | CS | pethoxamid | pethoxamid | mixed CS | co-CS |
| Weed | (375) | (375) | (800) | (375 + 800) | (375 + 775) | (375 + 775) |
| ANGAR | 100 | 98.8 | 100 | 100 | 100 | 100 |
| POLHY | 100 | 75 | 92.5 | 92.5 | 92 | 97.5 |
| POROL | 99.5 | 98.3 | 98.8 | 99.5 | 99.5 | 99.5 |
| POLLA | 99.3 | 98 | 49.3 | 67 | 71 | 76.3 |
| STEME | 99 | 99 | 91 | 99 | 99 | 98 |
| CAPBP | 98.8 | 100 | 99.3 | 100 | 99.5 | 97.5 |
| MATCH | 97.5 | 93.8 | 100 | 100 | 97.5 | 95 |
| VERPE | 95 | 97.5 | 54.4 | 98.8 | 91.9 | 96.3 |
| MERAN | 94.6 | 93.1 | 16.9 | 96.9 | 93.5 | 82.4 |
| CHEAL | 73.2 | 66.2 | 66.6 | 73.6 | 71.9 | 72.2 |
| POLPE | 69.9 | 75.4 | 61.8 | 73.3 | 78.3 | 79 |
| ABUTH | 66 | 56.7 | 38.9 | 71.9 | 70.6 | 68.8 |
| AMARE | 63.3 | 58.3 | 50.4 | 64.2 | 64.7 | 72.1 |
| SOLNI | 56.3 | 57.5 | 52.5 | 55 | 70 | 67.5 |
| GALAP | 55 | 60 | 7.5 | 60 | 56.3 | 56.3 |
| CHEPO | 30 | 50 | 30 | 30 | 80 | 65 |
| POLCO | 9 | 2.5 | 1.3 | 12.5 | 8.1 | 10.6 |
| SENVU | 7.5 | 23.8 | 13.8 | 22.5 | 57.5 | 35 |
| FUMOF | 0 | 0 | 12.5 | 10 | 18.8 | 21.3 |
| PANDI | 89.3 | 81 | 71.3 | 93.8 | 93 | 93.8 |
| SETVI | 82.4 | 81.3 | 81 | 86.5 | 84.8 | 80 |
| SORHA | 81.3 | 81.3 | 80 | 86.3 | 86.3 | 73.8 |

### Example 5. Pre-Emergence Application of Agrochemical Mixtures on Corn at Relatively Low Application Rates of Pethoxamid

Various forms, compositions, and mixtures of bixlozone and pethoxamid were applied to corn before emergence. For compositions of bixlozone only, minimal differences in performance between SC and CS were observed, except on POLSS, SOLNI, ABUTH, and ECHCG. Mixtures of bixlozone with 300 g/ha pethoxamid improved weed spectrum on a range of broad leaf weeds (e.g., SOLNI and ABUTH). Combinations of bixlozone and pethoxamid in pre-emergence applications were very safe with no clear pethoxamid rate effect. Tank mixes and premixes yielded comparable efficacies. Compositions including bixlozone+pethoxamid mixed CS exhibited increased efficacy compared to compositions including bixlozone+pethoxamid co-encapsulated CS for some broad leaf weeds (e.g., POLSS and SOLNI).

Table 13. Efficacies of various forms and mixtures of bixlozone and pethoxamid after pre-emergence application on corn. Weeds were present at ≥5 pl/m². Concentrations are shown in parentheses in g/ha.

| | Tank Mix | | | | Premix | |
|---|---|---|---|---|---|---|
| | | | | bixlozone | bixlozone + | bixlozone + |
| | bixlozone | bixlozone | | CS + | pethoxamid | pethoxamid |
| | SC | CS | pethoxamid | pethoxamid | mixed CS | co-CS |
| Weed | (375) | (375) | (300) | (375 + 300) | (375 + 300) | (375 + 300) |
| VERPE | 100 | 100 | 46.3 | 100 | 100 | 100 |
| LAMPU | 99.4 | 96.3 | 62.5 | 97.5 | 86.9 | 92.5 |
| POROL | 98 | 96.9 | 48.8 | 97.5 | 98.1 | 98.3 |
| POLPE | 97.8 | 93.9 | 45.5 | 95.4 | 94.8 | 91.5 |
| MATCH | 97.5 | 87.5 | 90 | 92.5 | 97.5 | 97.5 |
| CHEHY | 96.5 | 87 | 0 | 88.8 | 62.5 | 90.8 |
| POLLA | 86.9 | 81.7 | 42.2 | 91.5 | 87.6 | 80.1 |
| MERAN | 81.6 | 79.4 | 36.3 | 78 | 82.3 | 79.7 |
| DAUCA | 81.3 | 82.5 | 83 | 73.8 | 85 | 90 |
| ABUTH | 73.3 | 52.5 | 42.5 | 74.3 | 82.5 | 80 |
| SOLNI | 71.1 | 60.3 | 28.8 | 80.8 | 80.8 | 66.9 |
| CONAR | 67.1 | 65 | 39.6 | 61.3 | 57.9 | 62.9 |
| XANST | 63.8 | 45 | 35 | 72.5 | 65 | 75 |
| CHEAL | 63.4 | 63.8 | 35.7 | 73.4 | 67.9 | 66.7 |
| ACCVI | 60 | 76.3 | 65 | 66.3 | 67.5 | 75 |
| GALAP | 56.3 | 60 | 7.5 | 60 | 62.5 | 53.8 |
| MATIN | 52.5 | 77.3 | 50 | 80.5 | 89 | 84.8 |
| CAGSE | 15 | 12.5 | 10 | 56.3 | 33.8 | 10 |
| POAAN | 98.5 | 97.8 | 7.5 | 98.5 | 98 | 98.3 |
| PANDI | 95 | 85 | 68.8 | 95 | 93.8 | 90 |
| ECHCG | 89.6 | 83.3 | 48.4 | 88.6 | 89.2 | 86.1 |
| SETVI | 83.7 | 82 | 30 | 84.5 | 81.9 | 83 |

### Example 6. Pre-Emergence Application of Agrochemical Mixtures on Corn for Grass Weeds

Various forms, compositions, and mixtures of bixlozone and pethoxamid were applied to corn before emergence. Acceptable crop safety was observed for all combinations. A bixlozone CS (250 g/ha)+pethoxamid CS tank mix provided additional crop safety equivalent to a tank mix having only bixlozone SC at a reduced rate (150 g/ha). There was equivalent efficacy for fixed rate of bixlozone combined with pethoxamid: 1200 or 900 g/ha. Efficacy was reduced when bixlozone rate decreased from 250 to 150 g/ha. Rate-for-rate efficacy was lower for bixlozone CS (250 g/ha)+pethoxamid CS tank mixes compared to bixlozone SC+pethoxamid EC.

Table 14. Efficacies of various forms and mixtures of bixlozone and pethoxamid after pre-emergence application on corn. Weeds were present at ≥5 pl/m². Concentrations are shown in parentheses in g/ha.

| | Premix | | | | |
|---|---|---|---|---|---|
| | bixlozone + | bixlozone + | Tank Mix | | |
| | pethoxamid | pethoxamid | | | bixlozone CS + |
| | mixed CS | mixed CS | bixlozone | pethoxamid EC | pethoxamid EC |
| Weed | (300 + 850) | (300 + 300) | CS (300) | (850) | (300 + 850) |
| VERPE | 98.4 | 97.7 | 95.9 | 79.7 | 95.6 |
| MATCH | 98.3 | 93.9 | 53.2 | 97.1 | 98.8 |
| STEME | 97 | 96.4 | 93.8 | 68.1 | 95.1 |
| GERPU | 95.9 | 94.1 | 88 | 84.4 | 93.9 |
| MATIN | 93.5 | 90.5 | 79.8 | 88.6 | 94.2 |
| ARREB | 92.5 | 86.3 | 80 | 65 | 85 |
| GERMO | 92.5 | 87.5 | 91.8 | 90 | 92.5 |
| LAMPU | 89.8 | 87.8 | 80.1 | 71.5 | 87.1 |
| VERHE | 89.7 | 84.6 | 76.1 | 42.8 | 89.3 |
| VERAR | 88.8 | 83.8 | 82.5 | 47.5 | 82.5 |
| CHEAL | 88.1 | 86.3 | 81.3 | 88.1 | 86.9 |
| GIRAR | 87.5 | 80 | 73.8 | 80 | 88.8 |
| PAPRS | 87.5 | 85 | 82.5 | 83.8 | 87.5 |
| CAPBP | 86.6 | 84.8 | 73.8 | 73.2 | 82.3 |
| GERDI | 81.6 | 83 | 78.3 | 60.3 | 79.3 |
| GALAP | 75.6 | 69 | 76.3 | 61.3 | 72.5 |
| PAPRH | 73.9 | 69.7 | 53.4 | 68.7 | 77.3 |
| LITAR | 72.5 | 70 | 57.5 | 60 | 57.5 |
| DESSO | 65 | 65 | 0 | 35 | 65 |
| TRFIN | 65 | 85 | 77.5 | 60 | 65 |
| LAMAM | 62.5 | 67.1 | 47.1 | 37.9 | 65.4 |
| VIOAR | 57.8 | 51 | 43.3 | 46.8 | 57.7 |
| CENCY | 57.5 | 25 | 6.3 | 23.8 | 36.3 |
| POAAN | 98.4 | 95.4 | 74.5 | 87.2 | 97.3 |
| APESV | 94 | 80.6 | 46.6 | 78.8 | 91.1 |
| LOLMU | 82.4 | 75.3 | 76 | 70.3 | 78.1 |
| ALOMY | 67.5 | 68.8 | 32.5 | 26.3 | 70 |

### Example 7. Pre-Emergence Application of Agrochemical Mixtures on Corn for Weeds

Various normalities for mixtures of bixlozone and pethoxamid were applied to corn before emergence. Acceptable crop safety and good dose response were observed for all combinations. Good complementarity was observed between bixlozone and pethoxamid on many weeds.

Table 15. Efficacies of various normalities for mixtures of bixlozone and pethoxamid after pre-emergence application on corn. Weeds were present at ≥5 pl/m². Normalities are shown in parentheses.

| | Premix | | |
|---|---|---|---|
| | bixlozone + | bixlozone + | bixlozone + |
| | pethoxamid | pethoxamid mixed | pethoxamid mixed |
| Weed | mixed CS (1N) | CS (0.75N) | CS (0.5N) |
| VERPE | 98.4 | 95.3 | 92.5 |
| MATCH | 98.3 | 97.4 | 94 |
| STEME | 97 | 93.9 | 87.9 |
| GERPU | 95.9 | 90.1 | 82.6 |
| MATIN | 93.5 | 87.8 | 86 |
| ARREB | 92.5 | 91.3 | 87.5 |
| GERMO | 92.5 | 95.5 | 87.5 |
| LAMPU | 89.8 | 86.3 | 73.2 |
| VERHE | 89.7 | 84.7 | 61.3 |
| VERAR | 88.8 | 85 | 82.5 |
| CHEAL | 88.1 | 87.5 | 78.8 |
| GIRAR | 87.5 | 85 | 72.5 |
| PAPRS | 87.5 | 88.8 | 76.3 |
| CAPBP | 86.6 | 76.9 | 70.9 |
| GERDI | 81.6 | 78.4 | 67.1 |
| GALAP | 75.6 | 65.6 | 71.5 |
| PAPRH | 73.9 | 65.8 | 59.1 |
| LITAR | 72.5 | 70 | 70 |
| DESSO | 65 | 35 | 0 |
| TRFIN | 65 | 60 | 60 |
| LAMAM | 62.5 | 51.7 | 45.8 |
| VIOAR | 57.8 | 50.2 | 41.9 |
| CENCY | 57.5 | 40 | 42.5 |
| POAAN | 98.4 | 97.4 | 93.1 |
| APESV | 94 | 86.4 | 66.9 |
| LOLMU | 82.4 | 81.7 | 69.6 |
| ALOMY | 67.5 | 51.3 | 36.3 |

Table 16. Synergy data of various forms and mixtures of bixlozone and pethoxamid after pre-emergence application on corn. The notations in parentheses show the forms and amounts (in g/ha) of applied bixlozone and pethoxamid, respectively. Where “tank” is noted, the mix is a tank mix. Where “premix” is noted, the mix is a premix. Where there is no notation, the value shown is the Colby calculation for the expected value from separate mixtures.

Synergistic Efficacy

| | Colby | Obs-Exp | Obs-Exp |
|---|---|---|---|
| | (300CS + | (300CS + 850CS; | (300CS + 300CS; |
| Weed | 850EC) | premix) | premix) |
| APESV | 88.7 | 5.3 | −8.1 |
| ARREB | 93.0 | −0.5 | −6.7 |
| GIRAR | 94.7 | −12.2 | −17.2 |
| DESSO | 35.0 | 30.0 | 30.0 |
| DESSS | 84.3 | 2.0 | −11.8 |
| GERAR | 94.8 | −7.3 | −14.8 |
| GERDI | 83.8 | −0.4 | −1.0 |
| GERMO | 99.2 | −6.7 | −11.7 |
| GERPU | 98.1 | −2.2 | −4.0 |
| LAMAM | 67.1 | −4.6 | 0.0 |
| LAMPU | 94.7 | −3.9 | −5.8 |
| LITAR | 83.0 | −10.5 | −13.0 |
| LOLMU | 94.2 | −10.8 | −15.8 |
| MATCH | 96.8 | 0.4 | −9.7 |
| MATIN | 97.6 | −3.4 | −7.5 |
| PAPRH | 82.5 | −13.4 | −17.2 |
| POAAN | 95.3 | 3.1 | 1.0 |
| SSYOF | 88.9 | 4.1 | 2.9 |
| STEME | 98.0 | −1.0 | −1.6 |
| THLAR | 91.8 | 4.0 | 4.0 |
| TRFIN | 91.0 | −26.0 | −6.0 |
| VERAR | 90.8 | −2.0 | −7.0 |
| VERHE | 86.9 | 3.6 | −1.7 |
| VERPE | 99.1 | −1.3 | −1.9 |
| VIOAR | 70.6 | −11.5 | −17.8 |

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising”, it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular. The term “optionally” in connection with an ingredient or method in the present formulation alternatively means “present or absent”. The “optional” component is “present” or “absent” independent of the presence or absence of other formulating ingredients or steps unless otherwise noted or recited.

As used herein, depending on the context in which it is used, the term “about” provides an estimate of a value associated with the claimed invention, where the estimated value is reasonable when taken in context with the description of the invention and in view of what is known from information available to the public, as such information would be understood or interpreted by a person of ordinary skill in the art. Generally, the term “about” as used herein means that the estimated value will fall within plus or minus 10% of the associated value.

1. An agrochemical composition comprising:
bixlozone, wherein the bixlozone is encapsulated, non-encapsulated, or a mixture of encapsulated and non-encapsulated; and
pethoxamid;
wherein the bixlozone and the pethoxamid are present in synergistically effective amounts; and
wherein the bixlozone and the pethoxamid are present in a ratio of bixlozone:pethoxamid in the range of from about 1.25:1 to about 1:8.

2. The agrochemical composition of claim 1, wherein the bixlozone and the pethoxamid are present in a ratio in a range of from about 1.25:1 to about 1:3.2.

3. The agrochemical composition of claim 2 wherein the synergistic mixture further comprises beflubutamid or beflubutamid-M.

4. The agrochemical composition of claim 3, wherein the bixlozone is in a form selected from a suspension concentrate, a capsule suspension, an emulsifiable concentrate, a granule, a wettable granule, and combinations thereof.

5. The agrochemical composition of claim 4, wherein the pethoxamid is in a form selected from a suspension concentrate, a capsule suspension, a granule, a wettable granule, and combinations thereof.

6. The agrochemical composition of claim 5, wherein the pethoxamid is in a form selected from a suspension concentrate, a granule, a wettable granule, and combinations thereof.

7. The agrochemical composition of claim 6, wherein the pethoxamid is in a form of a suspension concentrate.

8. The agrochemical composition of claim 1, comprising:
(i) encapsulated bixlozone;
(ii) non-encapsulated bixlozone; and
(iii) pethoxamid.

9. The agrochemical composition of claim 8, wherein the encapsulated bixlozone and the non-encapsulated bixlozone are present in a ratio in the range of from about 1:9 to about 9:1.

10. The agrochemical composition of claim 9, wherein the encapsulated bixlozone and the non-encapsulated bixlozone are present in a ratio in the range of from about 1:3 to about 3:1.

11. The agrochemical composition of claim 10, wherein the encapsulated bixlozone is encapsulated with a material selected from polyurea, a biodegradable natural polymer, chitosan, wax, alginate, cellulose, gelatin, and combinations thereof.

12. The agrochemical composition of claim 11, wherein the agrochemical composition further comprises a safener selected from quinolinecarboxylic acid herbicides and agriculturally acceptable salts and esters thereof, cloquintocet mexyl, cyprosulfamide, mefenpyr, mefenpyr-diethyl, and combinations thereof.

13. The agrochemical composition of claim 12, wherein the agrochemical composition further comprises an auxiliary selected from dispersants, surfactants, biocides, antifoamers, antifreeze agents, rheology modifiers, surfactants, solvents, and combinations thereof.

14. The agrochemical composition of claim 13, wherein the agrochemical composition is in a form selected from a premix and a tank mix.

15. A method of preparing an agrochemical composition, the method comprising forming a mixture comprising:
(i) bixlozone, wherein the bixlozone is encapsulated, non-encapsulated, or a mixture of encapsulated and non-encapsulated; and
(ii) pethoxamid;
wherein the bixlozone and the pethoxamid are present in synergistically effective amounts; and
wherein the bixlozone and the pethoxamid are present in a ratio in the range of from about 1.25:1 to about 1:8.

16. The method of claim 15, wherein an amount of the bixlozone is encapsulated with a material selected from polyurea, a biodegradable natural polymer, chitosan, wax, alginate, cellulose, gelatin, and combinations thereof.

17. A method for controlling undesirable vegetation, the method comprising applying to the undesirable vegetation or to a locus thereof or applying to a soil to prevent an emergence or growth of the undesirable vegetation an agrochemical composition comprising:
bixlozone, wherein the bixlozone is encapsulated, non-encapsulated, or a mixture of encapsulated and non-encapsulated; and
pethoxamid;
wherein the bixlozone and the pethoxamid are present in synergistically effective amounts; and
wherein the bixlozone and the pethoxamid are present in a ratio in the range of from about 1.25:1 to about 1:8.

18. The method of claim 17, wherein the vegetation comprises at least one herbicide resistant or tolerant weed species.

19. The method of claim 18, wherein the vegetation comprises at least one susceptible weed species.

20. The method of claim 19, wherein the vegetation comprises a weed selected from a broad leaf weed and a grass weed.

21. (canceled)
